(19) United States
(12) Patent Application Publication
(10) Pub. No.: US 2015/0346773 A1
(43) Pub. Date: Dec. 3, 2015

(54) EXTENDABLE AUXILIARY DEVICE FOR PORTABLE TERMINAL HAVING A PORTABLE TERMINAL-SUPPORTING FUNCTION

(71) Applicant: SKYPOWERTEL INC., Gangseo-gu Seoul (KR)

(72) Inventor: Young-suk CHOI, Seoul (KR)

(73) Assignee: SKYPOWERTEL INC., Seoul (KR)

(21) Appl. No.: 14/655,006

(22) PCT Filed: Oct. 30, 2013
(86) PCT No.: PCT/KR2013/009718

§ 371 Date: Jun. 23, 2015

(30) Foreign Application Priority Data
Dec. 24, 2012 (KR) 10-2012-0151680

(51) Int. Cl. G06F 1/16; H02J 7/00

(52) U.S. Cl. CPC G06F 1/1632; G06F 1/1688; G06F 1/1686; G06F 1/1698; H02J 7/0044

(57) ABSTRACT

A portable terminal auxiliary device having a portable terminal support function is provided. The portable terminal auxiliary device includes: a body part having a front surface and a rear surface; a front surface connector provided on the front surface of the body part and connected to a connector of a portable terminal side so as to exchange power and signals; a stand provided on the front surface of the body part so as to support a portable terminal together with the body part; and a rear surface connector electrically connected to the front connector and provided on the rear surface of the body part so as to be connected to a front connector of a second auxiliary device. Additional auxiliary device can be further connected to the portable terminal auxiliary device capable of supporting a portable terminal.

### TECHNICAL FIELD

The present invention relates to an auxiliary device for portable terminal having a portable terminal-supporting function, more particularly, to an auxiliary device for portable terminal which can support various portable terminals such as portable phone, smartphone, portable game console, tablet, etc. and also function as an auxiliary battery, battery charger, external speaker, laser pointer, beam projector, etc. by being connected with the portable terminal in a wired or wireless manner.

### BACKGROUND ART

As a smartphone, a tablet, etc. are distributed, various operations such as watching moving images, reading an electronic book, listening to a music, surfing the internet, etc. are performed by the use of a portable terminal having a large screen. Furthermore, most of these operations are performed by directly touching the screen with the use of a touchscreen.

However, it is difficult to watch the movie or read the electronic book, holding the portable terminal for a long time, and thus, many supports for portable phone have been proposed on which the portable terminal is supported and used. Furthermore, a product has been proposed which has a function of charging the portable phone while supporting the latter. For example, Korean Laid-Open Patent Application No. 10-2011-0022753 discloses a structure capable of charging the portable phone while supporting the latter.

Meanwhile, a product having an additional function of speaker, amplifier, etc. as well as a function of simple support for portable phone is also proposed. For example, Korean Registered Patent No. 10-0663535 discloses a replaceable supporting/charging device for portable device which also has a function of speaker and which allows a user to listen to a music through an external speaker while the portable device is supported and charged on the support device.

However, such products are limited in terms of functions which can be added and thus do not meet the requirements of consumers who want to add various functions.

### SUMMARY OF THE INVENTION

### Technical Problems

The present invention has been made in the view of the above-mentioned matter, and its object is to provide an extendable auxiliary device for portable terminal having a portable terminal-supporting function which can support various portable terminals such as portable phone, smartphone, portable game console, tablet, etc. and also selectively have an extended function of an auxiliary battery, a battery charger, an external speaker, a laser pointer, a beam projector, etc. by being connected with the portable terminal in a wired or wireless manner.

### Solution to the Problem

To achieve the above object, an auxiliary device for portable terminal of the present invention includes a body part having a front surface and a rear surface; a front connector provided on the front surface of the body part and connected with a connector on the portable terminal side to allow transmission and reception of power and signals between the auxiliary device and the portable terminal; a stand provided on the front surface of the body part and supporting, together with the body part, the portable terminal; and a rear connector electrically connected to the front connector and provided on the rear surface of the body part to be connected with a front connector of a second auxiliary device. It is preferable that the stand is configured as a drawer type where the stand can be slidingly protruded out of or inserted into the body part. The front connector may be provided on the stand and exposed to the outside while the stand is slidingly protruded.

The auxiliary device for portable terminal of the present invention may further include a battery; and a charging unit which charges the battery through a power adaptor connected with the rear connector and which controls the power to be output from the battery to the outside through the front connector.

The auxiliary device for portable terminal of the present invention may be connected with a second auxiliary device. To this end, the rear surface of the auxiliary device for portable terminal may be provided with coupling means for coupling with the second auxiliary device.

The second auxiliary device according to an embodiment of the present invention includes a front connector to be connected with the rear connector of the auxiliary device for portable terminal; a beam projector unit receiving a signal input through the front connector and generating a beam project image; and a rear connector electrically connected to the front connector and connected with a front connector of a different second auxiliary device.

The second auxiliary device according to another embodiment of the present invention includes a front connector to be connected with the rear connector of the auxiliary device for portable terminal; a speaker unit amplifying an audio signal input through the front connector and generating a sound; and a rear connector electrically connected to the front connector and connected with a front connector of a different second auxiliary device.

The second auxiliary device according to yet another embodiment of the present invention includes a front connector to be connected with the rear connector of the auxiliary device for portable terminal; a Bluetooth unit for wireless transmission and reception of signal; a speaker unit amplifying an audio signal input through the Bluetooth unit and generating a sound; and a rear connector electrically connected to the front connector and connected with a front connector of a different second auxiliary device.

The second auxiliary device according to yet another embodiment of the present invention includes a front connector to be connected with the rear connector of the auxiliary device for portable terminal; a battery; a rear connector electrically connected to the front connector and connected with a front connector of a different second auxiliary device; and a charging unit which charges the battery through a power adaptor connected with the rear connector and which controls the power to be output from the battery to the outside through the front connector.

The second auxiliary device according to yet another embodiment of the present invention includes a front connector to be connected with the rear connector of the auxiliary device for portable terminal; an image-storing unit for storing an image signal input through the front connector; and a rear connector electrically connected to the front connector and connected with a front connector of a different second auxiliary device.

The second auxiliary device according to yet another embodiment of the present invention includes a front connector to be connected with the rear connector of the auxiliary device for portable terminal; a camera module for capturing images; an image-storing unit for storing signals of the images captured by the camera module; and a rear connector electrically connected to the front connector and connected with a front connector of a different second auxiliary device.

### Effects of the Invention

According to the present invention, a different auxiliary device can be used by being additionally connected with the auxiliary device for portable terminal capable of supporting the portable terminal, and therefore, the auxiliary device for portable terminal can be used while extended by the different auxiliary devices having various functions according to a user's requirement.

### BRIEF DESCRIPTION OF THE DRAWINGS

FIG. 1 is a perspective view of an auxiliary device for portable terminal according to an embodiment of the present invention, wherein (a) shows a state where a stand is retracted in a body part and (b) shows a state where the stand is protruded out of the body part;

FIG. 2 is a perspective view showing a state where the portable terminal is supported on the stand;

FIG. 3 is a side view showing the state where the portable terminal is supported on the stand, wherein (a) shows a state where the portable terminal is supported on the stand while connected with a front connector provided on the stand and (b) shows a state where the portable terminal is supported on the stand while not connected with the front connector provided on the stand;

FIG. 4 is a perspective view showing a state where the auxiliary device for portable terminal is connected with a second auxiliary device having a function of an external speaker;

FIG. 5(a) shows a rear surface of the auxiliary device for portable terminal and FIG. 5(b) shows a front surface of the second auxiliary device;

FIG. 6 is a perspective view showing a state where the auxiliary device for portable terminal is connected in a T-form with the second auxiliary device having the function of the external speaker; and

FIG. 7 is a block diagram shows an internal configuration of the auxiliary device for portable terminal according to an embodiment of the present invention.

### BEST MODES FOR CARRYING OUT THE INVENTION

In the following, a preferred embodiment of the present invention will be described in detail with reference to the attached drawings.

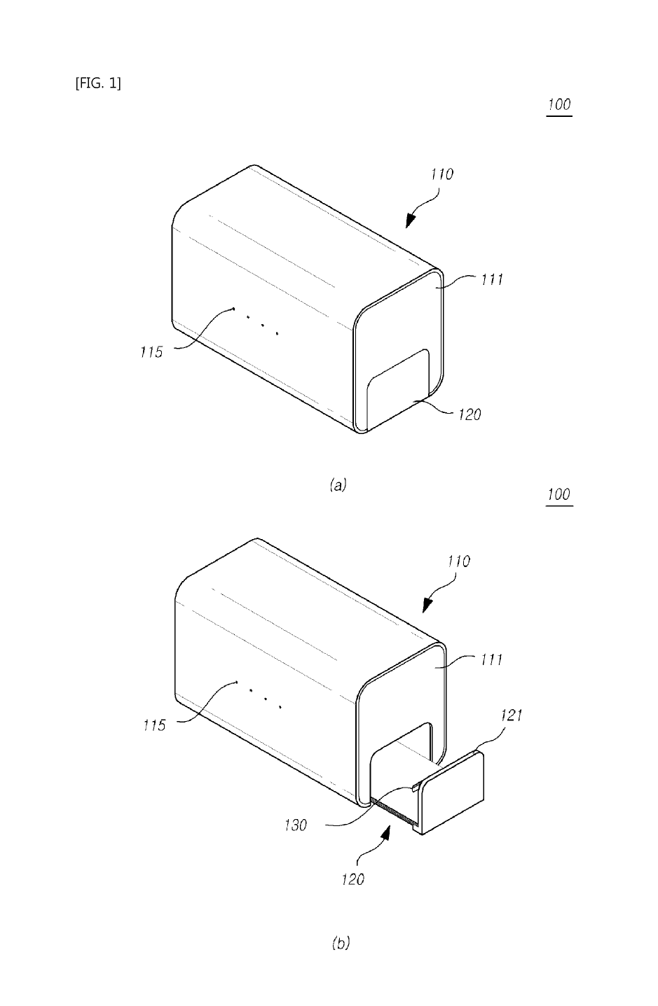

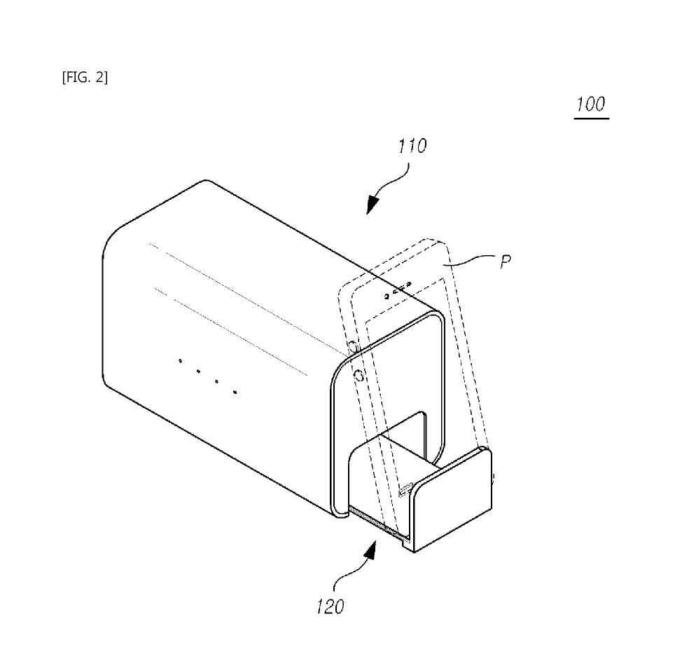

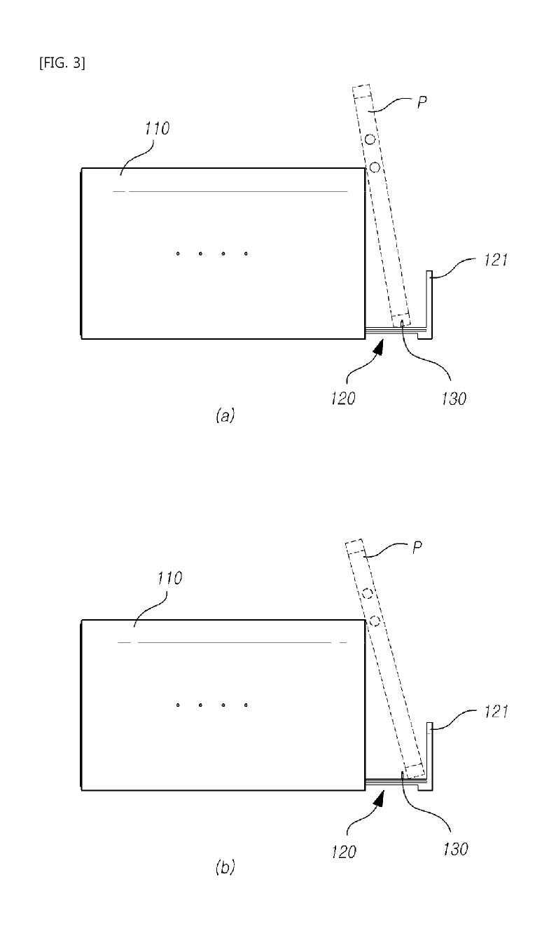

FIG. 1 is a perspective view of an auxiliary device for portable terminal according to a preferred embodiment of the present invention, wherein (a) shows a state where a stand is retracted in a body part and (b) shows a state where the stand is protruded out of the body part. FIG. 2 is a perspective view showing a state where the portable terminal is supported on the stand. FIG. 3 is a side view showing the state where the portable terminal is supported on the stand, wherein (a) shows a state where the portable terminal is supported on the stand while connected with a front connector provided on the stand and (b) shows a state where the portable terminal is supported on the stand while not connected with the front connector provided on the stand.

The auxiliary device for portable terminal (100) of the present invention includes the body part (110) and the stand (120) provided at the front of the body part (110). The stand (120) serves to support, together with the body part (110), the portable terminal (P), as illustrated in FIG. 2.

The body part (110) has a front surface (111) and a rear surface (112), wherein the front surface is provided with the front connector (130) and the rear surface is provided with a rear connector (140). A connector of the portable terminal (P) can be connected with the front connector (130) and a front connector of a second auxiliary device described later can be connected with the rear connector (140). If the connector of the portable terminal is connected with the front connector (130), transmission and reception of power and signals are allowed between the auxiliary device for portable terminal (100) of the present invention and the portable terminal (P). Furthermore, the front connector (130) and the rear connector (140) are electrically connected to each other, and thus, transmission and reception of the power and signals are allowed between the portable terminal (P) connected with the front connector (130) of the auxiliary device for portable terminal (100) and the second auxiliary device (200) connected with the rear connector (140) of the auxiliary device for portable terminal (100). Provided on a lateral surface is an indicator (115) showing a battery charge state described later, which indicator allows charged and discharged states of the battery housed in the body part (110) to be known.

The stand (120) may be configured as a drawer type where the stand can be slidingly protruded out of or inserted into the body part (110), as illustrated in FIG. 1. A protrusion (121) is provided at a front portion of the stand (120), which protrusion supports the supported portable terminal in such a way that the portable terminal does not slip.

According to a certain embodiment, the front connector (130) may be provided on the stand (120), as illustrated in FIG. 1(b). In this case, the front connector (130) can be exposed to the outside only while the stand (120) is slidingly protruded, and therefore, an external appearance of the auxiliary device for portable terminal (100) remains neat when the device is not in use.

In the embodiment of the present invention shown in FIGS. 1 to 3, the portable terminal (P) can be supported on the auxiliary device for portable terminal (100) even when a connector compatibility does not exist between the potable terminal (P) and the auxiliary device for portable terminal. FIG. 3(a) shows a state where the connector on the portable terminal (P) side is connected with the front connector (130) of the auxiliary device for portable terminal (100) when the a connector compatibility exists between the potable terminal (P) and the auxiliary device for portable terminal (100), and FIG. 3(b) shows a state where the portable terminal (P) is supported on the auxiliary device for portable terminal (100) while the connector on the portable terminal (P) side is not connected with the front connector (130) of the auxiliary device for portable terminal, regardless of the connector compatibility between the potable terminal (P) and the auxiliary device for portable terminal (100). As shown in FIG. 3(a), it is preferable that the front connector (130) is configured to be slightly inclined or to be rotatable so that the potable terminal (P) leans against the body part (110) when the connector on the portable terminal (P) side is connected with the front connector (130) of the auxiliary device for portable terminal (100). As shown in FIG. 3(b) where the connector on the portable terminal (P) side is not connected with the front connector (130) of the auxiliary device for portable terminal (100), the protrusion (121) of the stand (120) prevents the portable terminal (P) from slipping.

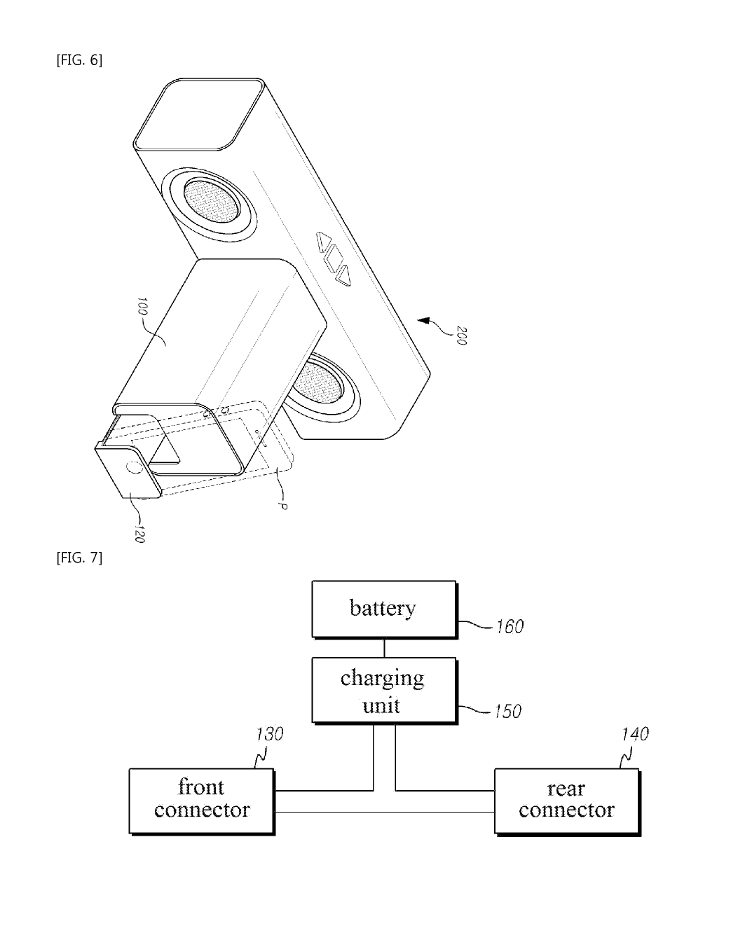

The auxiliary device for portable terminal of the present invention may be configured to have various functions in addition to the supporting function. FIG. 7 shows an internal configuration of the auxiliary device for portable terminal (100) having an additional charging function. In addition to the above-mentioned elements, the auxiliary device for portable terminal in FIG. 7 further includes a battery (160) and a charging unit (150) which charges the battery (160) through a power adaptor connected with the rear connector (140) and which controls the power to be output from the battery (160) to the portable terminal connected with the front connector (130). Furthermore, an indication device such as LED may be further included for indicating a charged state.

Additionally applied to the auxiliary device for portable terminal of the present invention may be various functions of laser pointer, Bluetooth speaker, external speaker, LED illumination device, aroma generating device or electronic mosquito incense-stick (a device for generating aroma/mosquito incense by the use of a heat generator using a battery power), beam projector, vehicle black box, etc.

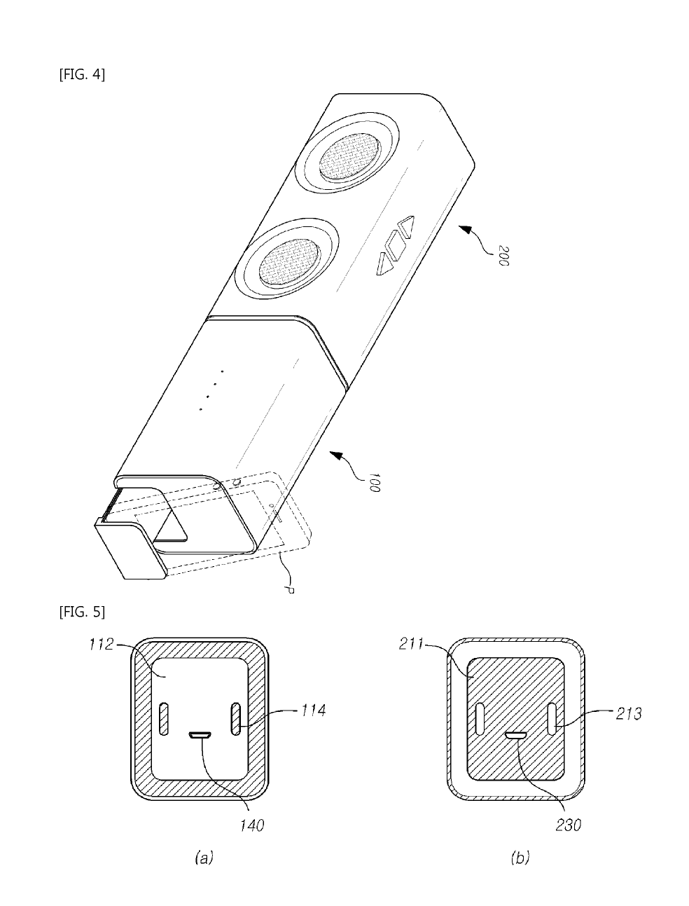

As described above, the front connector (230) of the second auxiliary device (200) may be connected with the rear connector (140) of the auxiliary device for portable terminal (100) of the present invention. FIG. 4 is a perspective view showing a state where the auxiliary device for portable terminal is connected with the second auxiliary device having a function of the external speaker, FIG. 5(a) shows the rear surface of the auxiliary device for portable terminal and FIG. 5(b) shows the front surface of the second auxiliary device, and FIG. 6 is a perspective view showing a state where the auxiliary device for portable terminal is connected in a T-form with the second auxiliary device having the function of the external speaker.

As illustrated in FIG. 4, by connecting the auxiliary device for portable terminal (100) of the present invention with the second auxiliary device (200), the function of the portable terminal may be further extended. To this end, the second auxiliary device (200) is provided with the front connector (230) to be connected with the rear connector (140) of the auxiliary device for portable terminal (100) and with a rear connector (not shown) electrically connected to the front connector (230) and connected with a front connector of a different second auxiliary device.

The rear surface (112) of the auxiliary device for portable terminal (100) may be provided with coupling means for coupling with the second auxiliary device (200). Likewise, a front surface (211) of the second auxiliary device (200) may be provided with coupling means for coupling with the auxiliary device for portable terminal (100). An example of such coupling means is shown in FIG. 5. In FIG. 5(a), the rear surface (112) of the auxiliary device for portable terminal (100) is provided with a protrusion (114) represented by hatched lines, and in FIG. 5(b), the front surface (211) of the second auxiliary device (200) is provided with a concave portion (213) at a position corresponding to the protrusion (114), which portion is represented by white color. Therefore, when the auxiliary device for portable terminal (100) and the second auxiliary device (200) are coupled with each other, the two auxiliary devices can be firmly locked.

The second auxiliary device (200) may be connected with a different second auxiliary device (200); to this end, the rear surface of the second auxiliary device (200) is also configured as in FIG. 5(a).

Added to the second auxiliary device (200) may be a function of, for example, auxiliary battery, laser pointer, Bluetooth speaker, external speaker, LED illumination device, aroma generating device or electronic mosquito incense-stick (a device for generating aroma/mosquito incense by the use of a heat generator using a battery power), beam projector, vehicle black box, portable loudspeaker (which is connected to the portable phone through wired or wireless data transmission and receives and amplifies voice input in the portable phone and thereafter outputs it through a speaker), alarm for repelling a molester, portable electric shaver, portable electric fan, portable electric driver, or portable electric toothbrush, etc. The second auxiliary device may be connected with a third or fourth auxiliary device having such a function, and therefore, the function of the portable terminal can be further extended.

Furthermore, the capacity of the auxiliary battery can be increased by additionally coupling an auxiliary batter of high capacity (for example, 5,000 mA or more) as the second auxiliary device to the auxiliary device for portable terminal (100) housing the battery. Furthermore, a time of use of the third auxiliary device having the function of the speaker or beam projector can be increased by coupling the third auxiliary device to the auxiliary device for portable terminal with an additional auxiliary battery coupled therewith.

As above, the second auxiliary device according to an embodiment of the present invention may include the front connector to be connected with the rear connector of the auxiliary device for portable terminal; the beam projector unit receiving a signal input through the front connector and generating a beam project image; and the rear connector electrically connected to the front connector and connected with a front connector of a different second auxiliary device.

The second auxiliary device according to another embodiment of the present invention includes the front connector to be connected with the rear connector of the auxiliary device for portable terminal; a speaker unit amplifying an audio signal input through the front connector and generating a sound; and the rear connector electrically connected to the front connector and connected with a front connector of a different second auxiliary device.

The second auxiliary device according to yet another embodiment of the present invention includes the front connector to be connected with the rear connector of the auxiliary device for portable terminal; a Bluetooth unit for wireless transmission and reception of signal; the speaker unit amplifying an audio signal input through the Bluetooth unit and generating a sound; and the rear connector electrically connected to the front connector and connected with a front connector of a different second auxiliary device.

The second auxiliary device according to yet another embodiment of the present invention includes the front connector to be connected with the rear connector of the auxiliary device for portable terminal; the battery; the rear connector electrically connected to the front connector and connected with a front connector of a different second auxiliary device; and the charging unit which charges the battery through the power adaptor connected with the rear connector and which controls the power to be output from the battery to the outside through the front connector.

The second auxiliary device according to yet another embodiment of the present invention includes the front connector to be connected with the rear connector of the auxiliary device for portable terminal; an image-storing unit for storing an image signal input through the front connector; and the rear connector electrically connected to the front connector and connected with a front connector of a different second auxiliary device.

The second auxiliary device according to yet another embodiment of the present invention includes the front connector to be connected with the rear connector of the auxiliary device for portable terminal; a camera module for capturing images; an image-storing unit for storing signals of the images captured by the camera module; and the rear connector electrically connected to the front connector and connected with a front connector of a different second auxiliary device.

Meanwhile, although an example has been described above where the portable terminal is connected with the auxiliary device for portable terminal through the front connector (130) thereof, the portable terminal may be charged in a wireless charging way or a communication between the portable terminal and the auxiliary device for portable terminal may be made in a wireless communication way such as Bluetooth or WiFi, etc. The present invention is not limited to a specific wireless charging way or wireless communication way. When such wireless charging way and wireless communication way are used, the front connector (130) for connection with the portable terminal may be omitted. Furthermore, the auxiliary device for portable terminal may be configured so that both of the connection through the front connector and the wireless charging/wireless communication are possible.

Although the preferred embodiments of the present invention have been described in detail as above, the scope of the present invention is not limited by the specific embodiments and should be construed by the appended claims of the present invention. Furthermore, those skilled in the art would understand that various modifications and alterations may be made without departing from the scope of the present invention.

### INDUSTRIAL APPLICABILITY

The present invention is applicable to the auxiliary device for portable terminal.

1. An auxiliary device for portable terminal, comprising:
a body part having a front surface and a rear surface;
a front connector provided on the front surface of the body part and connected with a connector on the portable terminal side to allow transmission and reception of power and signals between the auxiliary device and the portable terminal;
a stand provided on the front surface of the body part and supporting, together with the body part, the portable terminal; and
a rear connector electrically connected to the front connector and provided on the rear surface of the body part to be connected with a front connector of a second auxiliary device.

2. The auxiliary device for portable terminal according to claim 1, wherein the stand is configured as a drawer type where the stand can be slidingly protruded out of or inserted into the body part.

3. The auxiliary device for portable terminal according to claim 2, wherein the front connector is provided on the stand and exposed to the outside while the stand is slidingly protruded.

4. The auxiliary device for portable terminal according to claim 1, further comprising a battery; and a charging unit which charges the battery through a power adaptor connected with the rear connector and which controls the power to be output from the battery to the outside through the front connector.

5. The auxiliary device for portable terminal according to claim 1, wherein the rear surface is provided with coupling means for coupling with the second auxiliary device.

6. The auxiliary device for portable terminal according to claim 1, wherein the second auxiliary device comprises a front connector to be connected with the rear connector of the auxiliary device for portable terminal; a beam projector unit receiving a signal input through the front connector and generating a beam project image; and a rear connector electrically connected to the front connector and connected with a front connector of a different second auxiliary device.

7. The auxiliary device for portable terminal according to claim 1, wherein the second auxiliary device comprises a front connector to be connected with the rear connector of the auxiliary device for portable terminal; a speaker unit amplifying an audio signal input through the front connector and generating a sound; and a rear connector electrically connected to the front connector and connected with a front connector of a different second auxiliary device.

8. The auxiliary device for portable terminal according to claim 1, wherein the second auxiliary device comprises a front connector to be connected with the rear connector of the auxiliary device for portable terminal; a Bluetooth unit for wireless transmission and reception of signal; a speaker unit amplifying an audio signal input through the Bluetooth unit and generating a sound; and a rear connector electrically connected to the front connector and connected with a front connector of a different second auxiliary device.

9. The auxiliary device for portable terminal according to claim 1, wherein the second auxiliary device comprises a front connector to be connected with the rear connector of the auxiliary device for portable terminal; a battery; a rear connector electrically connected to the front connector and connected with a front connector of a different second auxiliary device; and a charging unit which charges the battery through a power adaptor connected with the rear connector and which controls the power to be output from the battery to the outside through the front connector.

10. The auxiliary device for portable terminal according to claim 1, wherein the second auxiliary device comprises a front connector to be connected with the rear connector of the auxiliary device for portable terminal; an image-storing unit for storing an image signal input through the front connector; and a rear connector electrically connected to the front connector and connected with a front connector of a different second auxiliary device.

11. The auxiliary device for portable terminal according to claim 1, wherein the second auxiliary device comprises a front connector to be connected with the rear connector of the auxiliary device for portable terminal; a camera module for capturing images; an image-storing unit for storing signals of the images captured by the camera module; and a rear connector electrically connected to the front connector and connected with a front connector of a different second auxiliary device.
